(19) United States
(12) Patent Application Publication
(10) Pub. No.: US 2024/0181668 A1
(43) Pub. Date: Jun. 6, 2024

(54) HOT CUTTING MECHANISM AND COMPOSITE SEVERING EQUIPMENT

(71) Applicant: CALB Co., Ltd., Jiangsu (CN)

(72) Inventors: Luoyi Xiang, Changzhou (CN); Zhengke Yang, Changzhou (CN); Jianzhong Xie, Changzhou (CN); Ruxin Song, Changzhou (CN)

(73) Assignee: CALB Co., Ltd., Jiangsu (CN)

(21) Appl. No.: 18/163,822

(22) Filed: Feb. 2, 2023

(30) Foreign Application Priority Data
Dec. 1, 2022 (CN) 202211527613.1

(51) Int. Cl. B26D 7/10; B26D 1/06

(52) U.S. Cl. CPC B26D 7/10; B26D 1/06

(57) ABSTRACT

A hot cutting mechanism and a composite severing equipment are provided. The hot cutting mechanism includes a hot cutting knife component, including two hot cutting knives disposed side by side along a first direction and used to cut an object to be cut at a same preset position; a driving mechanism, including a first driving mechanism used to drive the two hot cutting knives to reciprocate along a second direction and a second driving mechanism used to drive the two hot cutting knives to reciprocate along the first direction. The first direction is perpendicular to the second direction. The first direction is parallel to a transmission direction of the object to be cut.

### CROSS-REFERENCE TO RELATED APPLICATION

This application claims the priority benefit of China application serial no. 202211527613.1, filed on Dec. 1, 2022. The entirety of the above-mentioned patent application is hereby incorporated by reference herein and made a part of this specification.

### BACKGROUND

### Technical Field

The disclosure relates to the technical field of batteries, and in particular to a hot cutting mechanism and a composite severing equipment.

### Description of Related Art

When cutting a diaphragm, the diaphragm needs to be cut through a hot cutting knife, but currently one hot cutting knife is mainly used to cut the diaphragm. At present, the single-knife hot cutting mechanism is to use a single hot cutting knife to hot cut the diaphragm. The disadvantages of the present technology are as follows. Due to insufficient heat conduction of the single-knife hot cutting mechanism, the hot cutting temperature during the slicing process is not enough, so the cutting knife sticks to the diaphragm, which affects the final effect of hot cutting.

### SUMMARY

The disclosure provides a hot cutting mechanism, which includes a hot cutting knife component and a driving mechanism.

The hot cutting knife component includes two hot cutting knives disposed side by side along a first direction and used to cut an object to be cut at a same preset position.

The driving mechanism includes a first driving mechanism used to drive the two hot cutting knives to reciprocate along a second direction and a second driving mechanism used to drive the two hot cutting knives to reciprocate along the first direction.

The first direction is perpendicular to the second direction; and the first direction is parallel to a transmission direction of the object to be cut.

The disclosure also provides a composite severing equipment, which includes the hot cutting mechanism described above, a driving roller component used to transport an object to be cut, and a delivering component used to deliver the object to be cut. The delivering component is located between the driving roller component and the hot cutting mechanism.

### BRIEF DESCRIPTION OF THE DRAWINGS

For a better understanding of the disclosure, reference may be made to exemplary embodiments shown in the following drawings. The components in the drawings are not necessarily to scale and related elements may be omitted, or in some instances proportions may have been exaggerated, so as to emphasize and clearly illustrate the features described herein. In addition, related elements or components can be variously arranged, as known in the art. Further, in the drawings, like reference numerals designate same or like parts throughout the several views.

FIG. 1 is a structural schematic view of a composite severing equipment according to an embodiment of the disclosure.

FIG. 2 is a structural schematic view of a hot cutting mechanism according to an embodiment of the disclosure.

FIG. 3 is a structural schematic view of a movement mechanism according to an embodiment of the disclosure.

FIG. 4 is a cross-sectional view of a hot cutting mechanism according to an embodiment of the disclosure.

FIG. 5 is a partial enlarged view at a position A in FIG. 4.

FIG. 6 is a structural schematic view of an intermittent eccentric wheel according to an embodiment of the disclosure.

FIG. 7 is a structural schematic view of a damper according to an embodiment of the disclosure.

FIG. 8 is a schematic view of a driving roller component according to an embodiment of the disclosure.

FIG. 9 is a structural schematic view of a delivering component according to an embodiment of the disclosure.

### DETAILED DESCRIPTION OF DISCLOSED EMBODIMENTS

The technical solutions in the exemplary embodiments of the disclosure will be described clearly and explicitly in conjunction with the drawings in the exemplary embodiments of the disclosure. The description proposed herein is just the exemplary embodiments for the purpose of illustrations only, not intended to limit the scope of the disclosure, so it should be understood that and various modifications and variations could be made thereto without departing from the scope of the disclosure.

In the description of the present disclosure, unless otherwise specifically defined and limited, the terms “first”, “second” and the like are only used for illustrative purposes and are not to be construed as expressing or implying a relative importance. The term “plurality” is two or more. The term “and/or” includes any and all combinations of one or more of the associated listed items.

In particular, a reference to “the” object or “a” and “an” object is intended to denote also one of a possible plurality of such objects. Unless otherwise defined or described, the terms “connect”, “fix” should be broadly interpreted, for example, the term “connect” can be “fixedly connect”, “detachably connect”, “integrally connect”, “electrically connect” or “signal connect”. The term “connect” also can be “directly connect” or “indirectly connect via a medium”. For the persons skilled in the art, the specific meanings of the abovementioned terms in the present disclosure can be understood according to the specific situation.

Further, in the description of the present disclosure, it should be understood that spatially relative terms, such as “above”, “below” “inside”, “outside” and the like, are described based on orientations illustrated in the figures, but are not intended to limit the exemplary embodiments of the present disclosure.

In the context, it should also be understood that when an element or features is provided “outside” or “inside” of another element(s), it can be directly provided “outside” or “inside” of the other element, or be indirectly provided “outside” or “inside” of the another element(s) by an intermediate element.

The disclosure will be further described in detail through the drawings and embodiments below. Through the descriptions, the features and advantages of the disclosure will become clearer and more specific.

The word “exemplary” is used exclusively herein to mean “serving as an example, embodiment, or illustration”. Any embodiment described herein as “exemplary” is not necessarily to be construed as superior or better than other embodiments. While various aspects of the embodiments are shown in drawings, the drawings are not necessarily drawn to scale unless specifically indicated.

In addition, the technical features involved in different embodiments of the disclosure described below may be combined with each other as long as there is no conflict therebetween.

The disclosure provides a hot cutting mechanism and a composite severing equipment, which are used to improve the severing effect of an object to be cut.

In order to facilitate the understanding of a hot cutting mechanism according to an embodiment of the disclosure, the application scenario is firstly described. The hot cutting mechanism according to the embodiment of the disclosure is used to cut an object to be cut, so as to sever the object to be cut according to a preset length. When severing the object to be cut, the object to be cut needs to be cut by adopting a hot cutting manner. Currently, a single-point hot cutting mechanism is used to hot cut the object to be cut. However, due to insufficient heat conduction of the hot cutting mechanism, the temperature of a hot cutting knife during a slicing process is not enough, which may easily cause the hot cutting knife to stick to the object to be cut to affect the cutting effect. For this reason, the embodiment of the disclosure provides a hot cutting mechanism, which is used to improve the hot cutting effect of the object to be cut.

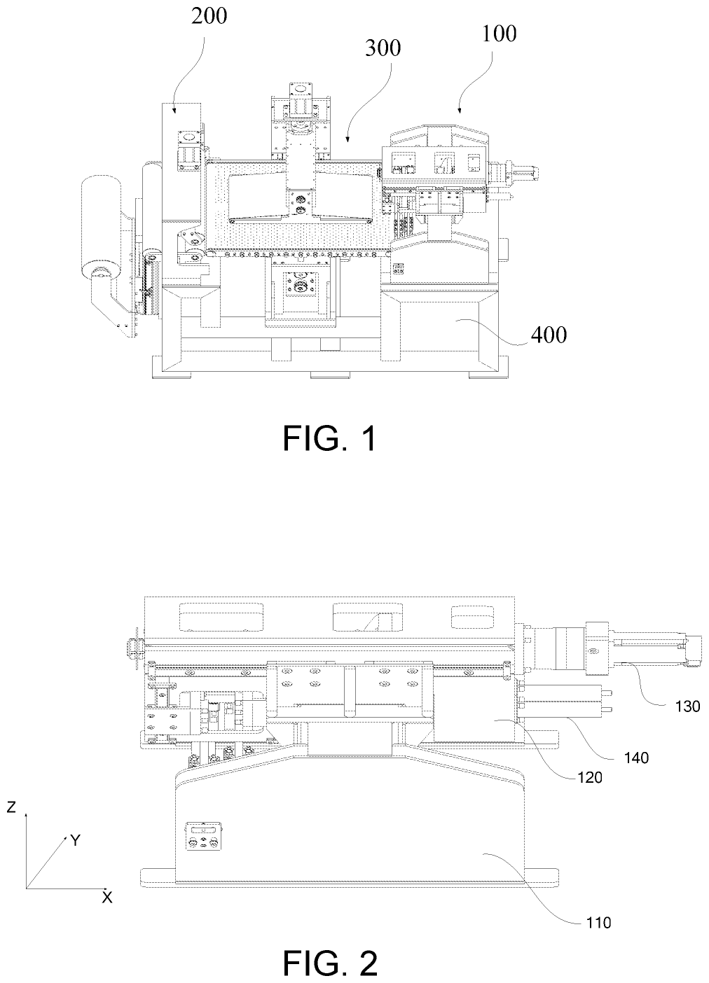

Referring to FIG. 1, FIG. 1 shows a schematic view of an application scenario of a hot cutting mechanism 100 according to an embodiment of the disclosure. The hot cutting mechanism 100 according to the embodiment of the disclosure is applied in a composite severing equipment. The composite severing equipment is used to cut the object to be cut and includes a driving roller component 200 used to transmit the object to be cut and the hot cutting mechanism 100 used to cut the object to be cut transported by the driving roller component 200. When in use, the object to be cut is transported through the driving roller component 200, and is cut by the hot cutting mechanism 100 after being sent into the hot cutting mechanism 100.

Referring to FIG. 2, FIG. 2 shows a schematic view of an overall structure of a hot cutting mechanism according to an embodiment of the disclosure. The hot cutting mechanism 100 includes a movement mechanism 120 and a supporting mechanism 110, wherein the movement mechanism 120 is used to support and transmit the object to be cut, and the movement mechanism 120 is used to cut the object to be cut.

In the embodiment of the disclosure, the supporting mechanism 110 includes a supporting seat 111. The supporting seat 111 is used to support the object to be cut and the movement mechanism 120.

In order to facilitate the description of the movement component. In the embodiment of this disclosure, an XYZ coordinate system is constructed, wherein an X direction is a delivering direction of the object to be cut and is also referred to as a first direction in the embodiment of the disclosure; a Y direction is located on the same horizontal plane as the X direction and is perpendicular to the X direction; and a Z direction is respectively perpendicular to the X direction and the Y direction, and the Z direction is also referred to as a second direction. In addition, when the object to be cut is taken as a reference object, the first direction is parallel to a transmission direction of the object to be cut, and the first direction is perpendicular to the second direction. The second direction may also be understood as a cutting direction when the hot cutting knife cuts the object to be cut.

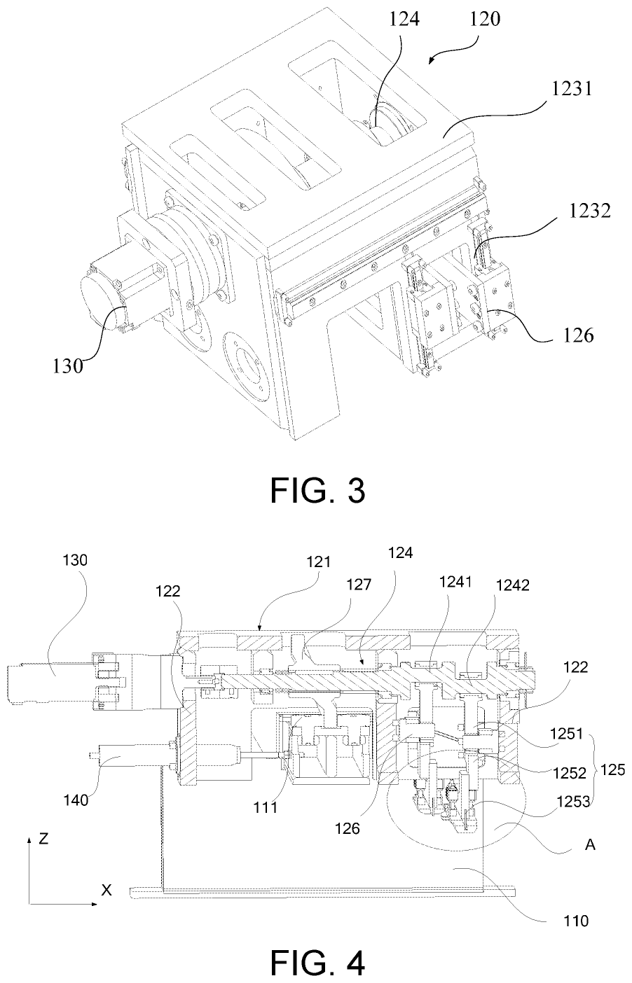

Referring to FIG. 3 and FIG. 4 together. FIG. 3 shows a structural schematic view of a movement mechanism, and FIG. 4 shows a cross-sectional view of a hot cutting mechanism. The movement mechanism 120 includes a hot cutting knife 125 component and a driving mechanism, wherein the hot cutting knife 125 component is used to cut the object to be cut, and the driving mechanism is used to drive the hot cutting knife 125 component to move. The movement mechanism 120 according to the embodiment of the disclosure will be firstly described below.

The hot cutting knife 125 component according to the embodiment of the disclosure includes two hot cutting knives 125, and the two hot cutting knives 125 are disposed side by side along the first direction (the X direction), and there is an interval of a certain distance between the two to ensure that the two hot cutting knives 125 may move independently. When cutting the object to be cut, the two hot cutting knives 125 are used to cut the object to be cut at a preset position.

Exemplarily, when cutting, the two hot cutting knives 125 reciprocate along a vertical direction to cut the object to be cut. The preset position refers to the two hot cutting knives 125 alternately cutting at the same position. Taking the XYZ coordinate system as a reference, if a coordinate of the preset position in the first direction is X1, when the two hot cutting knives 125 cut the object to be cut along the Z direction, coordinates of cutting positions of the two hot cutting knives 125 are both X1 in the first direction. In the embodiment of the disclosure, when the two hot cutting knives 125 are cutting at the preset position, the two hot cutting knives 125 are driven through the driving mechanism.

In order to implement the hot cutting knives 125 cutting the object to be cut at the same position, movements of the hot cutting knives 125 may be disassembled into movements in two directions, which are respectively vertical movement along the Z direction and horizontal movement along the X direction. The movement in the X direction ensures that the hot cutting knives 125 may correspond to the cutting position, and the movement in the Z direction ensures that the hot cutting knives 125 implements the cutting function.

When the driving mechanism drives the hot cutting knives 125 to move, according to the movement decomposition of the hot cutting knives 125, the driving mechanism may include two parts, which are respectively a first driving mechanism and a second driving mechanism. The first driving mechanism is used to drive the two hot cutting knives 125 to reciprocate along the second direction, that is, to drive the hot cutting knives 125 to reciprocate along the Z direction, so as to implement the cutting of the object to be cut. The second driving mechanism is used to drive the two hot cutting knives 125 to reciprocate along the first direction, that is, to drive the hot cutting knives 125 to reciprocate along the X direction, so that the hot cutting knives can move to the preset position during cutting. Therefore, when the two hot cutting knives 125 are cutting the object to be cut, the two hot cutting knives 125 may cut at the preset position.

In order to facilitate the understanding of the movement of the hot cutting knife 125 according to the embodiment of the disclosure, the same will be described in detail below in conjunction with specific drawings.

The specific configuration of the hot cutting knife 125 component according to the embodiment of the disclosure is firstly described. The movement mechanism 120 according to the embodiment of the disclosure includes a crankshaft 124 used to drive two hot cutting knives to move. In addition, the movement mechanism 120 also includes a structure used to support the crankshaft 124. The structure includes a first supporting frame 1231 and a second supporting frame 1232, wherein the first supporting frame 1231 and the second supporting frame 1232 are relatively fixed. During specific configuration, the first supporting frame 1231 is used to support the crankshaft 124, and the crankshaft 124 may rotate relative to the first supporting frame 1231. The second supporting frame 1232 is used to limit the movement of the hot cutting knife along the second direction.

During specific configuration, the first supporting frame 1231 and the second supporting frame 1232 may have an integrated structure or may be connected through connecting members (bolts or screws). Alternatively, a relatively fixed manner is adopted between the first supporting frame 1231 and the second supporting frame 1232. In the embodiment of the disclosure, the first supporting frame 1231 and the second supporting frame 1232 having the integrated structure is taken as an example for illustration. When the first supporting frame 1231 and the second supporting frame 1232 have the integrated structure, a supporting frame 121 is formed as a whole.

Exemplarily, the supporting frame 121 includes relatively disposed supporting plates 122 and a horizontal plate connecting two supporting plates 122, thereby forming an inverted U-shaped structure. Two ends of the crankshaft 124 respectively pass through the two supporting plates 122. In addition, the supporting frame 121 is also fixed with a first driving member driving the crankshaft 124 to rotate. An output shaft of the first driving member is coaxially fixed with the crankshaft 124 to drive the crankshaft 124 to rotate, thereby driving the hot cutting knife 125 to move. The crankshaft 124 and the driving member serve as the first driving mechanism to drive the hot cutting knife 125 to move along the second direction. That is, the first driving mechanism includes the crankshaft 124 rotatably connected to the supporting frame 121 and the first driving member driving the crankshaft 124 to rotate. Exemplarily, the first driving member is a driving motor 130. An output shaft of the driving motor 130 is coaxially fixed with the crankshaft.

The crankshaft 124 includes a first crankshaft portion 1241 and a second crankshaft portion 1242 arranged along the first direction. In addition, the first crankshaft portion 1241 and the second crankshaft portion 1242 are staggered along the second direction. The two hot cutting knives 125 are rotatably connected to the two crankshaft portions in one-to-one correspondence.

Exemplarily, the crankshaft 124 includes a front end shaft and a rear end shaft, and also includes a crank and a connecting rod shaft located between the front end shaft and the rear end shaft, wherein the connecting rod shaft is connected to the front end shaft or the rear end shaft through the crank. In the embodiment of the disclosure, the number of connecting rod shafts is two, and the two connecting rod shafts respectively serve as the first crankshaft portion 1241 and the second crankshaft portion 1242. During assembly, the two hot cutting knives 125 are respectively rotatably connected to the two crankshaft portions in one-to-one correspondence. When the crankshaft 124 rotates, the crankshaft 124 is used to provide power for the two hot cutting knives 125 to alternately move along the Z direction.

When the first crankshaft portion 1241 and the second crankshaft portion 1242 rotate, the first crankshaft portion 1241 and the second crankshaft portion 1242 both make circular movements. In order to ensure that the two hot cutting knives 125 may move along the Z direction when moving, the hot cutting knives 125 adopt a hinged structure.

Exemplarily, each hot cutting knife 125 includes a rotating rod 1251 and a straight rod 1252 rotatably connected to the rotating rod 1251. In addition, a cutter head 1253 disposed on the straight rod 1252 is also included. During specific assembly, the rotating rod 1251 and the straight rod 1252 are arranged along the Z direction, one end of the rotating rod 1251 is sleeved on the crankshaft portion, and the other end of the rotating rod 1251 is hinged to one end of the straight rod 1252. The other end of the rotating rod 1251 is fixedly connected to the cutter head 1253. That is, along the Z direction, the rotating rod 1251, the straight rod 1252, and the cutter head 1253 are sequentially arranged, and the cutter head 1253 is located at the end away from the crankshaft 124.

Referring to FIG. 2, FIG. 3, and FIG. 4 together, in order to ensure that the hot cutting knife 125 may vertically move along the Z direction, the straight rod 1252 is slidably connected to the supporting frame 121. Exemplarily, the supporting plate 122 is provided with a sleeve 126 used to cooperate with the hot cutting knife 125, and the straight rod 1252 is sleeved in the sleeve 126 and is slidably connected to the sleeve 126, wherein the two ends of the straight rod 1252 are respectively exposed outside the two ends of the sleeve 126 along the Z direction. It should be understood that a part where the crankshaft 124 is connected to the supporting plate 122 is divided into the first supporting frame 1231; and a position where the straight rod 1252 is slidably connected to the supporting frame 121 is divided into the second supporting frame 1232.

When the crankshaft 124 moves, taking the first crankshaft portion 1241 as an example, the first crankshaft portion 1241 drives one end of the rotating rod 1251 to make a circular movement. Due to the limitation of the sleeve 126, when the rotating rod 1251 rotates, the rotating rod 1251 rotates relative to the straight rod 1252, and drives the straight rod 1252 to slide along the Z direction, and within one week of rotation of the rotating rod 1251, the straight rod 1252 moves from the highest end to the lowest end along the Z direction, and then moves to the highest end, so as to complete one movement cycle. Also, in the movement cycle, the cutter head 1253 cuts the object to be cut when the straight rod 1252 moves to the lowest end, and stays away from the object to be cut when the straight rod 1252 moves to the highest end. The object to be cut may continue to move under transportation by a delivering device, so that the next cut is at the same position.

As an optional solution, in order to ensure the stability when cutting. The hot cutting knife 125 according to the embodiment of the disclosure also includes an elastic pressing seat. The elastic pressing seat is used to compact the cutter head 1253 when cutting the object to be cut. Exemplarily, the elastic pressing seat is disposed at the end of the straight rod 1252 away from the rotating rod 1251 and is used to abut against the object to be cut.

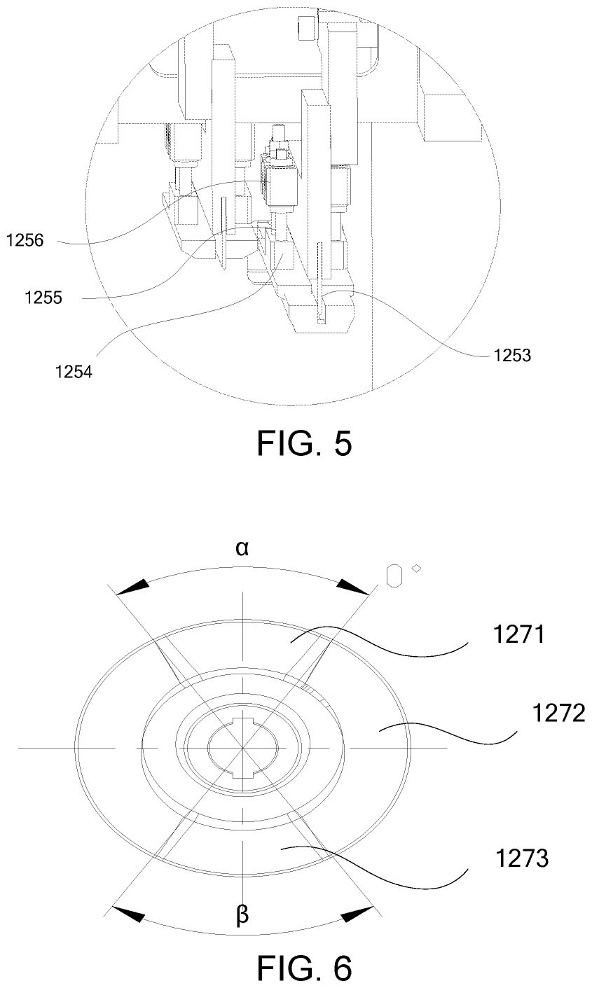

Referring to FIG. 5, FIG. 5 shows a partial enlarged view at a position A in FIG. 4. The elastic pressing seat includes a limiting rod 1255 fixedly connected to the end of the straight rod 1252 away from the rotating rod 1251 and a pressing block 1254 sleeved on the limiting rod 1255; and also includes a compression spring 1256 passing through the limiting rod 1255. Two ends of the compression spring 1256 respectively press against the straight rod 1252 and the pressing block 1254 in one-to-one correspondence. Exemplarily, the compression spring is sleeved on the straight rod 1252, one end of the compression spring presses against a protruding shoulder disposed on the straight rod 1252, and the other end of the compression spring presses against the pressing block 1254.

The pressing block 1254 is a hollow structure, a cavity for accommodating the cutter head 1253 is disposed inside, and a cutter hole for the cutter head 1253 to protrude is correspondingly disposed at the end of the pressing block 1254 away from the straight rod 1252.

During the movement of the straight rod 1252 toward the object to be cut, the cutter head 1253 is located inside the cavity in the pressing block 1254 and is not exposed. When the hot cutting knife 125 descends and contacts the object to be cut, the pressing block 1254 first contacts the object to be cut to compact the object to be cut. When the straight rod 1252 continues to move, the elastic member 1256 is compressed, and the cutter head 1253 starts to move relative to the pressing block 1254 and is partially exposed outside the pressing block 1254, so as to cut the object to be cut. During the entire cutting process, the pressing block 1254 compacts the object to be cut. After cutting the object to be cut, the straight rod 1252 starts to move toward a direction away from the object to be cut, the cutter head 1253 is first separated from the object to be cut, and the pressing block 1254 is then separated, which prevents the cutter head 1253 from attaching to and moving the object to be cut, so as to ensure the stability of the position of the object to be cut during the entire cutting process.

In the above solution, the movement of one hot cutting knife 125 when cutting the object to be cut is exemplified. In the embodiment of the disclosure, when the number of the hot cutting knives 125 is two, and the two hot cutting knives 125 alternately cut the object to be cut, the hot cutting knives 125 need to be driven to move in the X direction through the second driving mechanism, so as to ensure that the preset position may be moved for cutting when the hot cutting knives 125 are cutting. The second driving mechanism according to the embodiment of the disclosure will be described in detail below.

In the embodiment of the disclosure, the second driving mechanism includes a second driving member. The second driving member is connected to the crankshaft 124 and used to drive the crankshaft 124 to reciprocate along the first direction. That is, in the embodiment of the disclosure, the second driving member drives the crankshaft 124 to move along the first direction, thereby driving the two hot cutting knives 125 to switch.

It should be understood that the second driving mechanism according to the embodiment of the disclosure is used in cooperation with the first driving mechanism, which need to synchronously drive the hot cutting knives 125 to move in the first direction and the second direction during the movement of the hot cutting knives 125.

For the convenience of explaining the cooperation movement of the first driving mechanism and the second driving mechanism, next, the movement of the hot cutting knife 125 is disassembled. Taking one hot cutting knife 125 as an example, the reciprocating movement thereof in the first direction is between a point a and a point b, wherein the point b corresponds to the preset position where the hot cutting knife 125 cuts the object to be cut. The reciprocating movement in the second direction is between a point c and a point d, wherein the point d corresponds to a position where the hot cutting knife 125 cuts the object to be cut, and the point c is a position where the hot cutting knife 125 rises to the highest point.

Taking one of the hot cutting knives 125 as an example, when the hot cutting knife 125 cuts the object to be cut, the hot cutting knife 125 is located at the point b in the first direction and is located at the point d in the second direction. When the hot cutting knife 125 finishes cutting, the first driving mechanism and the second driving mechanism drive the hot cutting knife 125 to start moving. Driven by the first driving mechanism, the crankshaft 124 rotates by half a rotation, and the first driving mechanism drives the hot cutting knife 125 to move from the point d to the point c point, while the second driving mechanism drives the hot cutting knife 125 to move from the point b to the point a. When the first driving mechanism and the second driving mechanism drive one of the hot cutting knives 125 to start to descend and cut the object to be cut, the other hot cutting knife 125 is synchronously driven to start to rise.

When specifically configuring the second driving mechanism, the second driving mechanism may be a driving mechanism having a power source or may adopt the same power source (the driving motor 130) as the first driving mechanism, which is not specifically limited in the embodiment of the disclosure. The structure in which the second driving mechanism and the first driving mechanism share the same power source is taken as an example for illustration below.

When adopting the above manner for configuration, the supporting frame 121 is slidably connected to the supporting seat 111, and a sliding direction of the supporting frame 121 is along the first direction. Exemplarily, a sliding track is disposed on the supporting seat 111, a length direction of the sliding track is along the first direction, and the supporting frame 121 is slidably assembled on the sliding track, so as to implement the reciprocating sliding of the supporting frame 121 along the first direction, thereby driving the two hot cutting knives 125 to reciprocate along the first direction. When the first supporting frame 1231 and the second supporting frame 1232 are adopted to form the supporting frame 121, the second supporting frame 1232 is slidably connected to the supporting seat 111.

When the second driving mechanism and the first driving mechanism adopt the same power source, the second driving member may be an intermittent eccentric wheel 127. The intermittent eccentric wheel 127 has multiple surfaces. The corresponding supporting seat 111 is provided with a driving surface correspondingly in cooperation with the surface of the intermittent eccentric wheel 127, which will be respectively described below.

First, the intermittent eccentric wheel 127 is disposed on the crankshaft 124, exemplarily, the intermittent eccentric wheel 127 is located at the front end shaft or the rear end shaft of the crankshaft 124. The intermittent eccentric wheel 127 has two surfaces relatively disposed along the first direction.

Referring to FIG. 6, FIG. 6 shows a structural schematic view of an intermittent eccentric wheel. Taking one of the surfaces as an example, the surface includes a first plane 1271 and a second plane 1273 respectively arranged on two opposite sides of the crankshaft 124 and an arc-shaped transition surface 1272 connected to the first plane 1271 and the second plane 1273, wherein the first plane 1271 and the second plane 1273 are arranged at an interval along the first direction.

When specifically configuring the first plane 1271, the second plane 1273, and the transition surface 1272, the first plane 1271 and the second plane 1273 are arranged at an interval along the X direction, and the first plane 1271 and the second plane 1273 are connected through the transition surface 1272. The transition surface 1272 is an arc-shaped transition surface.

During cooperation, the first plane 1271, the second plane 1273, and the transition surface 1272 are respectively used to cooperate with the driving surface. Exemplarily, when the first plane 1271 or the second plane 1273 cooperates with the driving surface, when the intermittent eccentric wheel 127 rotates, since the first plane 1271 is a plane perpendicular to the first direction, the crankshaft 124 does not move. When the transition surface 1272 cooperates with the driving surface, since the transition surface 1272 is a surface connecting the first plane 1271 and the second plane 1273, when the driving surface contacts the transition surface 1272, the crankshaft 124 is driven to move along the first direction.

The first plane 1271 and the second plane 1273 are used to respectively correspond to the positions of the two hot cutting knives 125 in the first direction when the two hot cutting knives 125 are moving in the vertical direction. Exemplarily, when the driving surface abuts the first plane 1271, the cutter head 1253 of one of the two hot cutting knives 125 abuts to the preset position. When the driving surface abuts the second plane 1273, the cutter head 1253 of the other one of the two hot cutting knives 125 abuts to the preset position. The transition surface 1272 is used to drive the two hot cutting knives 125 to respectively move in the first direction and the second direction.

Combining with the driving of the movement of the hot cutting knife 125 in the first direction and the second direction. When the first plane 1271 cooperates with the driving surface, the hot cutting knife 125 only moves along the second direction. When the second plane 1273 cooperates with the driving surface, the hot cutting knife 125 only moves along the second direction. When the transition surface 1272 cooperates with the driving surface, the hot cutting knife 125 moves along the first direction, while also moving along the second direction.

The hot cutting knife 125 moving along the point a to the point b of the first direction is taken as an example, and along the point c to the point d of the second direction is taken as an example.

When the first plane 1271 cooperates with the driving surface, the hot cutting knife 125 is located at the point a in the first direction, and moves in the direction away from the object to be cut from the point d in the second direction. When the transition surface 1272 cooperates with the driving surface, the hot cutting knife 125 moves along the point a to the point b of the first direction, and the hot cutting knife 125 continues to move in the direction away from the object to be cut in the second direction. When the second plane 1273 cooperates with the driving surface, the hot cutting knife 125 is located at the point b in the first direction, and continues to move to the point c in the second direction, thereby completing cutting. Similarly, when the hot cutting knife 125 moves along the above direction, the other hot cutting knife 125 correspondingly moves, and moves from the highest point to the lowest point in the second direction, and moves from away from the preset position in the first direction to the preset position corresponding to cutting.

As an optional solution, the first plane 1271 and the second plane 1273 are axisymmetrically disposed. For example, included angles between the first plane 1271 and the second plane 1273 are respectively α and β, and α=β.

When the crankshaft 124 rotates 0° to α°, the hot cutting knife 125 only moves up and down, and at α° to 180°, the hot cutting knife 125 moves both horizontally and up and down.

When the crankshaft 124 rotates 0° to α°, the horizontal displacement of the hot cutting knife 125 is 0, and the hot cutting knife 125 moves up and down. Exemplarily, the hot cutting knife 125 descends at 0° to ½α°, the hot cutting knife 125 descends to the lowest point when rotated to ½α°, the hot cutting knife 125 rises at ½° to α°, and the hot cutting knife 125 rises to the highest point when rotated to α°.

When the crankshaft 124 rotates α° to 180°, the hot cutting knife 125 has both horizontal displacement and vertical displacement. Exemplarily, when the crankshaft 124 rotates 180° to β°, the horizontal displacement of the hot cutting knife 125 is 0, the hot cutting knife 125 moves up and down, the hot cutting knife 125 descends at 0° to ½β°, the hot cutting knife 125 descends to the lowest point when rotated to ½β°, the hot cutting knife 125 rises at ½β° to β°, and the hot cutting knife 125 rises to the highest point when rotated to β°.

When the crankshaft 124 rotates β° to 360°, the hot cutting knife has both horizontal displacement and vertical displacement.

It can be seen from the above description that in the embodiment of the disclosure, through adopting the two hot cutting knives to cut the object to be cut, the hot cutting knives can be ensured to effectively cut the object to be cut, and the severing effect of the object to be cut is improved.

As an optional solution, in order to ensure the effect of cooperation between the driving surface and the first plane 1271, the second plane 1273, and the transition surface 1272, a roller may be disposed on the driving surface. The roller abuts the surface of the intermittent eccentric wheel 127. Thus, sliding friction between the surface of the intermittent eccentric wheel 127 and the driving surface is converted into rolling friction. A friction force between the two is reduced, thereby improving the driving effect of the second driving mechanism.

As an optional solution, the number of the driving surfaces is two, and the two driving surfaces are relatively disposed. The intermittent eccentric wheel 127 is located between the two driving surfaces. When adopting the structure, the two driving surfaces respectively abut two opposite surfaces of the intermittent eccentric wheel 127, so that during a rotating process of the intermittent eccentric wheel 127, the crankshaft 124 may be driven to reciprocate along the first direction, thereby driving the two hot cutting knives 125 to reciprocate along the first direction.

Of course, in addition to the two driving surfaces of the above example, one driving surface may also be adopted. When adopting one driving surface, an elastic member is disposed between the corresponding supporting frame 121 and the supporting seat 111, and the elastic member is used to push the supporting frame 121 to slide relative to the supporting seat 111. Exemplarily, when the first plane 1271 contacts the driving surface, the elastic member is stretched. When the transition surface 1272 or the second plane 1273 contacts the driving surface, an elastic force of the elastic member keeps the transition surface 1272 in contact with the driving surface.

As an optional solution, in order to ensure the stability of the supporting frame 121 when moving, the hot cutting mechanism 100 further includes a damper 140 disposed between the supporting seat 111 and the supporting frame 121. The damper 140 is respectively connected to the supporting seat 111 and the supporting frame 121, and is used to reduce swaying of the supporting frame 121 relative to the supporting seat 111.

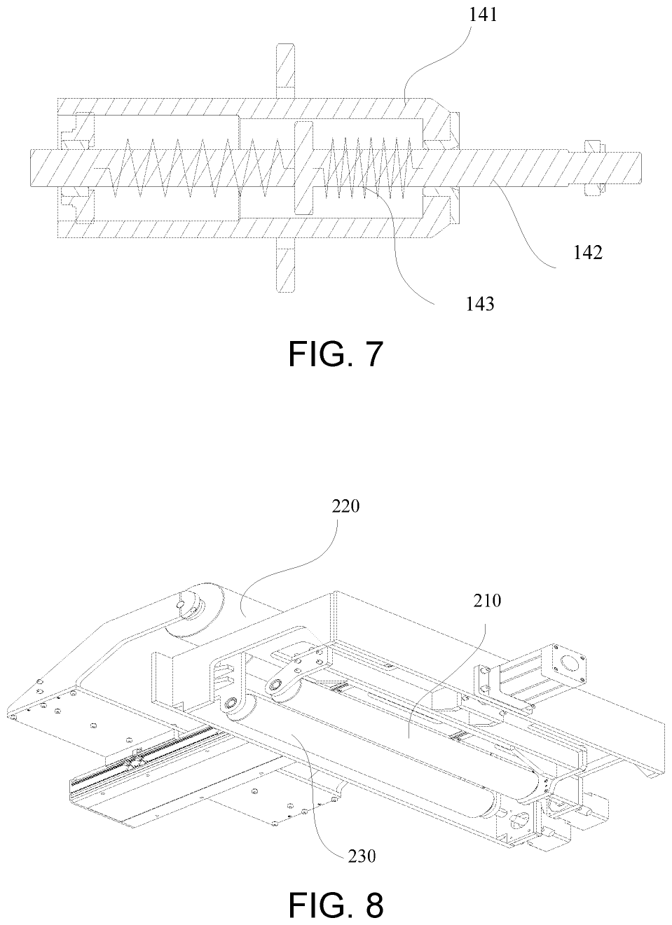

Referring to FIG. 7, FIG. 7 shows a structural schematic view of a damper. When specifically configuring the damper 140, the damper 140 includes a case 141 fixed on the supporting frame 121 and a damping rod 142 sleeved in the case 141. The damping rod 142 is fixedly connected to the supporting seat 111. An elastic compression member 143 is also included. One end of the elastic compression member 143 presses against the damping rod 142, and the other end is presses against the case 141. Exemplarily, the number of the elastic compression members 143 is two, which are respectively a spring.

When in use, the damping rod 142 is initially located at a neutral position, and the deformation of the two springs is the same. When the supporting frame 121 of the hot cutting knife 125 is horizontally displaced, one end of the spring is compressed, and the other end of the spring is stretched. When the damping rod 142 reaches a limit position, the deformation of the spring is the greatest, and the spring may provide a certain force to reduce an output torque of a motor during rebound. Therefore, the supporting frame 121 is more stable when moving.

Continuing to refer to FIG. 1, as an optional solution, the hot cutting mechanism 100 according to the embodiment of the disclosure further includes a base 400. The base 400 is used to support the supporting seat 111. During configuration, the supporting seat 111 is rotatably connected to the base 400 and may be locked at the preset position, wherein an axis around which the supporting seat 111 rotates is parallel to the second direction. When the object to be cut is transmitted to the supporting seat 111, the supporting seat 111 may form a certain included angle with the transmission direction of the object to be cut, thereby causing an inclination when cutting the object to be cut. For this reason, in the example of this disclosure, the supporting seat 111 may rotate relative to the base 400 to adjust the supporting seat 111 to be parallel to the transmission direction of the object to be cut, thereby ensuring the cutting effect.

During specific adjustment, an automatic adjustment manner may be adopted. Exemplarily, the hot cutting mechanism 100 also includes a visual component, a driving component, and a control module. The visual component is disposed on the supporting seat 111 and is used to detect the object to be cut, specifically detect the included angle between the transmission direction of the object to be cut and the supporting seat 111. The transmission direction of the object to be cut may be a length direction of the object to be cut. The driving component is used to drive the supporting seat 111 to rotate, so as to adjust the angle of the supporting seat 111 relative to the object to be cut. The control module is used to control the driving component to drive the supporting seat 111 to rotate according to an angle difference between the transmission direction of the object to be cut detected by the visual component and a preset direction.

A visual component may be a camera, a camera les, or other equipment capable of capturing images. When a control module receives an image captured by the visual component, the image is processed, and the included angle between the length direction of the object to be cut and the supporting seat 111 is obtained. The included angle is an angle for adjusting the supporting seat 111. The image processing may adopt conventional image processing, which will not be described in detail here.

It can be seen from the above description that the overall adjustment of the supporting seat 111 may be implemented through configuring the visual component, the driving component, and the control module.

The driving component may be the driving motor 130 with a gear component, and the supporting seat 111 is driven to rotate through engagement of gears. The control module may be a common control module such as a PLC or an industrial personal computer, which will not be described in detail here.

An embodiment of the disclosure also provides a composite severing equipment. The composite severing equipment includes the hot cutting mechanism 100 described above and the driving roller component 200 used to transport the object to be cut.

Referring to FIG. 1 and FIG. 8 together, the driving roller component 200 includes a first driving roller 210, a second driving roller 220, and a third driving roller 230, wherein the first driving roller 210 is located on one side of the object to be cut, and the second driving roller 220 and the third driving roller 230 are located on the other side of the object to be cut. Moreover, a rotating direction of the first driving roller 210 is opposite to directions of the second driving roller 220 and the third driving roller 230. Therefore, the object to be cut may be pressed while being transported.

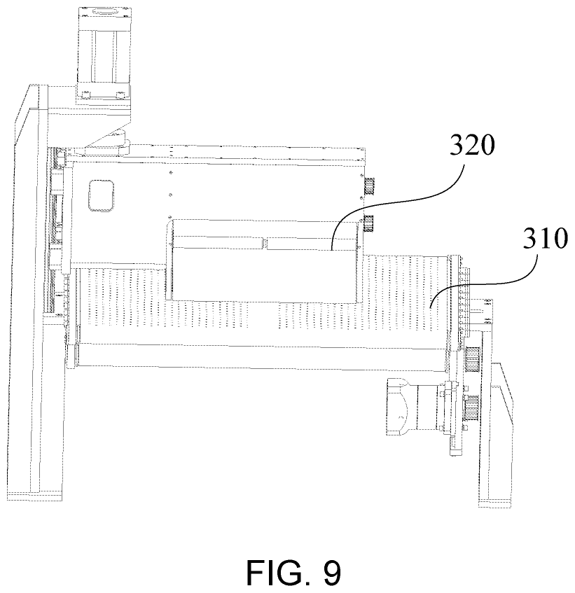

Referring to FIG. 1 and FIG. 9 together, as an optional solution, a delivering component 300 is also included. The delivering component 300 is used to deliver the object to be cut. The delivering component 300 is disposed between the driving roller component 200 and the hot cutting mechanism 100, and is used to transport the object to be cut. Exemplarily, the delivering component 300 includes a conveyor 310 and a pressing plate 320 disposed on the conveyor 310.

The pressing plate 320 is located above the conveyor 310 and is used to compact the object to be cut, so as to ensure the stability of the object to be cut when moving.

As an optional solution, the conveyor 310 is also provided with vacuum suction holes, which are used to ensure the stability of the object to be cut when moving when delivering the object to be cut.

In the description of the disclosure, it should be noted that terms such as “upper”, “lower”, “inner”, “outer”, “front”, “rear”, “left”, and “right” that indicate an orientation or positional relationship is an orientation or positional relationship based on the working state of the disclosure, and is only for the convenience of describing the disclosure and simplifying the description, rather than indicating or implying that the indicated device or element must have a specific orientation or be constructed and operated in a specific orientation. Therefore, the terms should not be construed as limiting the disclosure.

In the description of the disclosure, it should be noted that unless otherwise specified and limited, the terms “installation”, “relation”, and “connection” should be interpreted in a broad sense. Persons of ordinary skill in the art may understand the specific meanings of the above terms in the disclosure according to specific situations.

Other embodiments of the disclosure will be apparent to those skilled in the art from consideration of the specification and practice of the disclosure disclosed herein. The disclosure is intended to cover any variations, uses or adaptations of the disclosure. These variations, uses, or adaptations follow the general principles of the disclosure and include common general knowledge or conventional technical means in the art that are not disclosed in the present disclosure. The specification and embodiments are illustrative, and the real scope and spirit of the present disclosure is defined by the appended claims.

It should be understood that the disclosure is not limited to the precise structures that have been described above and shown in the drawings, and various modifications and variations can be made without departing from the scope thereof. The scope of the disclosure is limited only by the appended claims.

What is claimed is:

1. A hot cutting mechanism, comprising:
a hot cutting knife component, comprising two hot cutting knives disposed side by side along a first direction and used to cut an object to be cut at a same preset position;
a driving mechanism, comprising a first driving mechanism used to drive the two hot cutting knives to reciprocate along a second direction and a second driving mechanism used to drive the two hot cutting knives to reciprocate along the first direction, wherein
the first direction is perpendicular to the second direction; and the first direction is parallel to a transmission direction of the object to be cut.

2. The hot cutting mechanism according to claim 1, further comprising a first supporting frame and a second supporting frame fixed relative to the first supporting frame, wherein
the first driving mechanism comprises a crankshaft rotatably connected to the first supporting frame and a first driving member driving the crankshaft to rotate, wherein
the crankshaft comprises a first crankshaft portion and a second crankshaft portion arranged along the first direction, wherein the first crankshaft portion and the second crankshaft portion are staggered along the second direction;
each of the hot cutting knives comprises a rotating rod and a straight rod rotatably connected to the rotating rod, and further comprises a cutter head disposed on the straight rod, wherein the straight rod is slidably connected to the second supporting frame, and a sliding direction of the straight rod is along the second direction;
the rotating rod of one of the two hot cutting knives is rotatably connected to the first crankshaft portion, and the rotating rod of other one of the hot cutting knives is rotatably connected to the second crankshaft portion.

3. The hot cutting mechanism according to claim 2, wherein the second driving mechanism comprises a second driving member; the second driving member is fixedly connected to the crankshaft, and the second driving member is used to drive the crankshaft to reciprocate along the first direction.

4. The hot cutting mechanism according to claim 3, further comprising a supporting seat, wherein
the second driving member is an intermittent eccentric wheel disposed on the crankshaft, wherein
the intermittent eccentric wheel has two surfaces relatively disposed along the first direction, wherein each of the surfaces comprises a first plane and a second plane respectively arranged on two opposite sides of the crankshaft and an arc-shaped transition surface connected to the first plane and the second plane, wherein the first plane and the second plane are arranged at an interval along the first direction;
the supporting seat is provided with a driving surface abutting a surface of the intermittent eccentric wheel;
when the driving surface abuts the first plane, the cutter head of one of the two hot cutting knives abuts to the preset position;
when the driving surface abuts the second plane, the cutter head of other one of the two hot cutting knives abuts to the preset position.

5. The hot cutting mechanism according to claim 4, wherein the first plane and the second plane are axisymmetrically disposed.

6. The hot cutting mechanism according to claim 5, wherein a roller is disposed on the driving surface, and the roller abuts the surface of the intermittent eccentric wheel.

7. The hot cutting mechanism according to claim 6, wherein a number of the driving surfaces is two, and the two driving surfaces are relatively disposed; the intermittent eccentric wheel is located between the two driving surfaces.

8. The hot cutting mechanism according to claim 4, wherein each of the hot cutting knives further comprises an elastic pressing seat used to abut against the object to be cut; the elastic pressing seat is connected to an end of the straight rod away from the rotating rod.

9. The hot cutting mechanism according to claim 8, wherein the elastic pressing seat comprises a limiting rod fixedly connected to the end of the straight rod away from the rotating rod and a pressing block sleeved on the limiting rod; and further comprises a compression spring passing through the limiting rod and with two ends respectively pressing against the straight rod and the pressing block in one-to-one correspondence.

10. The hot cutting mechanism according to claim 4, wherein the second supporting frame is slidably connected to the supporting seat, and a sliding direction of the second supporting frame is along the first direction.

11. The hot cutting mechanism according to claim 10, further comprising:
a damper, wherein the damper comprises a case fixed on the supporting frame and a damping rod sleeved in the case; the damping rod is fixedly connected to the supporting seat;
an elastic compression member, wherein one end of the elastic compression member presses against the damping rod, and other end presses against the case.

12. The hot cutting mechanism according to claim 4, further comprising a base, wherein the supporting seat is rotatably connected to the base and is locked at a preset position, wherein an axis around which the supporting seat rotates is parallel to the second direction.

13. The hot cutting mechanism according to claim 5, further comprising a base, wherein the supporting seat is rotatably connected to the base and is locked at a preset position, wherein an axis around which the supporting seat rotates is parallel to the second direction.

14. The hot cutting mechanism according to claim 6, further comprising a base, wherein the supporting seat is rotatably connected to the base and is locked at a preset position, wherein an axis around which the supporting seat rotates is parallel to the second direction.

15. The hot cutting mechanism according to claim 7, further comprising a base, wherein the supporting seat is rotatably connected to the base and is locked at a preset position, wherein an axis around which the supporting seat rotates is parallel to the second direction.

16. The hot cutting mechanism according to claim 8, further comprising a base, wherein the supporting seat is rotatably connected to the base and is locked at a preset position, wherein an axis around which the supporting seat rotates is parallel to the second direction.

17. The hot cutting mechanism according to claim 9, further comprising a base, wherein the supporting seat is rotatably connected to the base and is locked at a preset position, wherein an axis around which the supporting seat rotates is parallel to the second direction.

18. The hot cutting mechanism according to claim 10, further comprising a base, wherein the supporting seat is rotatably connected to the base and is locked at a preset position, wherein an axis around which the supporting seat rotates is parallel to the second direction.

19. The hot cutting mechanism according to claim 12, further comprising:
a visual component, disposed on the supporting seat and used to detect the object to be cut;
a driving component, used to drive the supporting seat to rotate;
a control module, used to control the driving component to drive the supporting seat to rotate according to an angle difference between the transmission direction of the object to be cut detected by the visual component and a preset direction.

20. A composite severing equipment, comprising the hot cutting mechanism according to claim 1, a driving roller component used to transport an object to be cut, and a delivering component used to deliver the object to be cut, wherein the delivering component is located between the driving roller component and the hot cutting mechanism.
